(19) United States
(12) Patent Application Publication
(10) Pub. No.: US 2018/0321896 A1
(43) Pub. Date: Nov. 8, 2018

(54) Fuel Dispensing System with Secondary Display Optimized For Full Service Stations

(71) Applicant: Miguel S. Giacaman, Henderson, NV (US)

(72) Inventor: Miguel S. Giacaman, Henderson, NV (US)

(21) Appl. No.: 16/039,318

(22) Filed: Jul. 18, 2018

Related U.S. Application Data
(63) Continuation-in-part of application No. 10/491,325, filed on Jul. 27, 2004, now Pat. No. 10,077,769.
(60) Provisional application No. 62/533,818, filed on Jul. 18, 2017.
(60) Provisional application No. 62/547,104, filed on Aug. 18, 2017.

(51) Int. Cl. G06F 3/14; G05D 7/06

(52) U.S. Cl. CPC G06F 3/1454; G05D 7/0676

(57) ABSTRACT

A fueling dispensing display system with an electronic display located at a position that is visible and convenient to a vehicle driver for monitoring fueling operation pertaining fuel dispensing. The system receives and displays information concerning fuel dispensing that allows a driver of a vehicle to visualize initialization cycle, product selection, price per unit of volume, fuel dispensing progress, and end of sale final values. The system automatically and continuously displays the information during the fueling operations and the end of sale values on located displays. Alternatively, the system can display the information on portable devices, remote terminals, or database structure in either physical or virtual environment.

### CROSS-REFERENCE TO RELATED APPLICATION

The present application is a Continuation In-Part application of the U.S. Provisional Application No. 62/533,818 filed on Jul. 18, 2017, U.S. Provisional Application No. 62/547,104 filed on Aug. 18, 2017, and U.S. Nonprovisional application Ser. No. 10/491,325 filed on Jul. 27, 2004, each in their entirety incorporated herein by reference.

### BACKGROUND

### 1. Field of the Invention

The present invention relates to a fuel dispensing system for a vehicle driver to visually monitor the fueling operations to the vehicle while the driver is not manipulating the fuel dispenser and the fuel dispenser displays are obstructed or not within eyesight of the driver.

### 2. Background of the Invention

Fuel service stations, also known as gas stations use a fuel management control system that communicates with the several fuel dispensers located on the site. The system includes a Point of Sales (POS) that communicates with the fuel dispensers via a fuel dispenser controller. The fuel dispenser controller commonly known as site controller could be based on a microcomputer and firmware or a computer and software. The POS also controls fueling operation status such as nozzle in and/or out, type of selected fuel, price per unit (PPU), preset volume to be dispensed, etc. via the fuel dispenser controller.

Before fuel flow, the fuel dispenser display shows initial zeroing of all the indicators, price per unit of volume also called PPU and the product selected. Once fuel flow begins, it displays the amount and volume being dispensed as the fueling operation progresses. When fuel dispensing operation ends, it displays the final values of the transaction including final amount, final volume, PPU and product dispensed.

The same information plus nozzle in/status out can be visualized remotely at a point of sale (POS) computer screen that is usually located at the office or convenience store or on portable devices handled by the attendant.

The fuel dispenser controller connects with the POS and connects and control the fuel dispensers. The fuel dispenser controller sends data to the fuel dispensers via a digital data line and a proprietary protocol messaging means to the fuel dispensers including price of the fuel to be dispensed, preset of maximum amounts or volume of fuel to dispense, authorization to dispense fuel, etc. The fuel dispensers then send data back to the fuel dispenser controller that may include fueling point number, dispenser status, RTI and EOS information, PPU, electronic totalizers, error codes, etc. The fuel dispenser controller is the first line of communication with the fuel dispensers by means of a serial port, or a proprietary electrical interface and a messaging proprietary protocol of the manufacturer of the fuel dispensers.

Most fuel dispensers have at least one or more electronic displays located on a position optimized to be visually seen by the person performing the fueling operation at self-service gas stations or by attendants on full-service gas stations to allow them to oversee the fueling operation.

The fuel dispenser's displays show a field for each of the following information: initial zeroing of all the indicators and then the amount and volume being dispensed, price per unit of volume (PPU) and product selected. Once the fueling operation ends they show the final values of the transaction including final amount, final volume, PPU and product dispensed.

The same information plus nozzle in/out can be visualized remotely at a point of sale (POS) computer screen that is usually located at the office or convenience store or on portable devices handled by the attendant.

A disadvantage of the conventional fuel display is that, on most vehicles, it is not easily visualized by the vehicle driver while being seating in the vehicle. The vehicle driver has more difficulty to view the fuel display when the vehicle's fuel tank opening is located on the opposite side of the driver's seat (right side for most vehicles). The driver is further away from the fuel dispenser as the fuel dispenser's displays are usually at a higher than the roof of the vehicle this roof further blocks the line of site from the driver to the fuel dispenser's displays.

Furthermore, in order to get the fuel tank opening near the fuel nozzle, the vehicle driver has to position the vehicle ahead of the center of the dispenser, and therefore the fuel display becomes out of eyesight while being in the vehicle and the fuel is being delivered by an attendant. It is then difficult for the vehicle driver to detect errors of the fueling operations such as wrong fuel type selection, over or under fueling volume or amount requested, or being cheated by the operator. Because of these limitations, many drivers prefer to step out of the vehicle to better supervise the fueling operation.

It is then difficult for the vehicle driver and/or owner to detect errors of the fueling operations such as wrong fuel type selection, over or under fueling volume or amount requested, or being cheated by the operator.

Thus, there is a need for a fuel dispensing system with a conveniently located display to allow the vehicle driver to monitor the initialization of the indicators on the fuel dispenser, the RTI once the fuel flow begins and EOS values once the fueling operation has finished while the driver is not manipulating the fuel dispenser to fuel the vehicle and is seated inside the vehicle that is being fueled up.

### SUMMARY OF THE INVENTION

### Definitions

The term “dispenser” means equipment used to deliver fuel to vehicles at fuel service stations. For a purpose of the present invention, the dispenser may at least one secondary display whereas primary displays are optional. A dispenser as in prior art have primary displays only.

The term “attendant” means person manipulation the fuel dispenser to perform a fueling to a vehicle and works at the fuel service station.

The term “fueling point” means a fueling position. If a dispenser is capable of fueling two vehicles simultaneously, then it would have two fueling points.

The term “RTI” means Real Time Information indicates the amount and volume dispensed while the fuel is being delivered to a vehicle. This information also indicates the status of the fueling operation, including handle up (or nozzle out) handle down (or nozzle in), type of fuel selected and price per unit (aka PPU). This information is normally visualized by means of a primary display on the upper section of a fuel dispenser and it is automatically and continuously being displayed during the fueling operation. And, once the fueling operation has concluded, the Real Time Information (RTI) should be equal to the amount and volume indicated by the End of Sale values (EOS). For comparison, RTI is different than information contained in a database with the sales than occurred within a period of time, like a work shift or one day, which reflects fueling operations that have concluded, hence, it's not real time information.

The term “EOS information” means the information related to the final values of a fuel delivered into a vehicle and includes the final amount, volume and fuel product delivered as well as the PPU.

The term “POS” means Point of sale, is a computer either hardware or virtual that runs at least one sales management application.

The term “Primary Display” means the conventional display usually on the upper part of a dispenser and mechanically integrated inside the dispenser enclosure and centered or proximately centered to the front of the dispenser's enclosure and facing to the person operating the dispenser. It is one or more per dispenser and its location is optimized to be easily visualized by the person manipulating the dispenser, either a driver or a passenger on a self-service station or an attendant on a full service station.

The term “Pump Computer” means the electronic computer system inside a fuel dispenser. It's usually located on the upper part of a dispenser inside an enclosure separated from the lower part of the dispenser by a safety barrier called “vapors barrier” that prevents fuel vapors to enter the electric space on top. The pump computer computes the signals provided by the electromechanical fuel metering system, calculates at least the amount and volume dispensed and shows these values along with PPU and product selected on the primary display. Additionally, the pump computer control most aspect of the operation of the dispenser, including but not limited to the fuel valves and sensing the nozzle activation. One important feature of the pump computer is to provide with a data communications line to send information in and out of the dispenser. This data communications line can connect with internal or external fuel dispenser control equipment or system as well as a secondary display.

The term “secondary display” means fuel dispenser display located and positioned to allow the vehicle driver to monitor the fueling operation being performed by an attendant or a passenger while the driver is seated on the driver's seat inside the vehicle that is being fueled up. It displays unit that show the zeroing, RTI and EOS information other than the displays that comes with the dispensers.

The term “zeroing” means indication on the fuel dispenser's displays that the indicators of amount and volume have been initialized a value of zero.

The present invention provides a fuel dispensing system with a secondary electronic display that is located on a position that allows to be easily visualized by the driver when seated “close” or “away” from the fuel dispenser.

The term “Fueling point” means a fueling position. If a dispenser is capable of fueling two vehicles simultaneously then it would have two fueling points

The term “EOS” means the information related to the final values of a fuel delivered into a vehicle and includes the final amount, volume and fuel product delivered

The term “RTI” means Real Time Information indicating the amount of money and/or volume of fuel dispensed while the fuel is being delivered to a vehicle. This information may also indicate the status of the fueling operation, including handle up (or nozzle out) handle down (or nozzle in), fuel product selected and price per unit of volume (aka PPU). This information is normally visualized by means of a primary display on the upper section of a fuel dispenser and it is automatically and continuously being displayed during the fueling operation. And, once the fueling operation has concluded, the RTI should be equal to the amount and volume indicated by the EOS.

The term “POS” means a computer either hardware or virtual that runs at least one sales management application.

The term “Dedicated Pump Controller” means a dispenser controller device that is installed, one per fuel pump, proximate and in connection with each said fuel pump, is capable of functioning as a pump controller dedicated solely to the pump for which it is installed. This dedicated pump controller contains a microcomputer with a (brand-specific) pump communications interface and optionally a communications interface with a conventional (remote or external) main pump controller, which is non-dedicated and has control over one or more pumps at the gas station. If connected to such a main pump controller, the device may function as a slave to this main pump controller. Otherwise it may function autonomously to control the fuel pump on its own.

Preferably, the RTI and EOS information relating to a fueling operation is transmitted from the fuel dispenser's pump computer via a data communication line into one or more secondary or accessory displays at the convenience of the vehicle driver line of sight.

Preferably, the RTI and EOS information can be visualized on at least one large size display per fuel dispenser which is mounted on the proximate side of the fuel dispenser within eyesight of the driver or in a position ahead of the dispenser and in front to the driver seated in the vehicle.

The term “Initialization” means an indication on the fuel dispenser's displays either primary or secondary, that the indicators of amount and volume have been initialized to a value of zero.

The term “driver seat position” means once the vehicle is parked in front of the dispenser, the driver seat may be on the “close” side when the driver is closer to the dispenser than a front passenger seat and “away” side when the driver seat is further from the dispenser than a front passenger.

The term “Synchronization” means agile communication with the dispenser's metering system or pump computer to allow the secondary display to show the amount and volume dispensed with less than one second delay in reference to the actual volume and money being delivered to the vehicle. Less than one second would be the maximum time delay and less than one third of second desirable. This delay should be within these maximum limits even with all the fueling points active.

Preferably, the system of the present invention includes one or more fuel dispensers having one or more primary display wherein other fuel dispensers have no primary display, a plurality of secondary or additional display optimized to have a field of view within the visibility of a vehicle driver who is seating in the vehicle, and at least one data communication channel to communicatively links the secondary electronic display to the fuel dispenser pump computer for synchronizing the information with the fuel dispenser metering system via the pump computer.

As the fuel dispenser controller connects with the POS and connects and controls the fuel dispensers, it sends data to the fuel dispensers via a digital data line and a proprietary protocol messaging to the fuel dispensers including price of the fuel to be dispensed, preset of maximum amounts or volume of fuel to dispense, pump authorization to dispense fuel, etc. The fuel dispensers then send data back to the fuel dispenser controller that may include fueling point number, dispenser status, RTI and EOS information, PPU, electronic totalizers, error codes, etc. The fuel dispenser controller is the first line of communication with the fuel dispensers by means of a serial port or proprietary electrical interface and a messaging proprietary protocol of the manufacturer of the fuel dispensers.

Preferably, the RTI is obtained by the computerized device from the fuel dispenser pump computer via the data communication line and is transmitted to a portable device such as smart phone, tablet or notebook. The portable device automatically and continuously acquires RTI data streaming and EOS information to allow the vehicle driver to view the fueling operations on a portable device's display via a computer software executable on a computer microprocessor.

Preferably, the fuel dispensing system uses an algorithm performed by using the computer software on the portable device to detect and alert errors and/or bad fueling transaction when the fuel volume and/or type is not within previously set limits or not fueling at all. In this embodiment, before the fueling operation, the driver sets up on the smart phone application the types of fuel and the maximum volume or amount allowed to be delivered into the vehicle. If the attendant selects the wrong fuel type or delivers an amount or volume higher than the limit preset, the smart phone application would detect the error and sets an alarm, either visual or audible on the smartphone and or send a message to the control system on the station to immediately and automatically cancel the fueling operation.

Preferably, the fuel dispensing system can generate automatic notifications to indicate fuel dispenser status as well as log fuel quantity to alert the vehicle driver that the fuel dispenser has been initialized to zero amount and volume and the amount of fuel actually delivered rather than relying on service personnel to manually report or log fuel quantity. The notifications, reports and/or alerts can be reported on the driver's smartphone or email via remote communications to a remote system.

Preferably, the Initialization, RTI and EOS information is obtained by the computerized device from the fuel dispenser pump computer via the data communication line and is transmitted to a portable device such as smartphone, tablet or notebook. The portable device automatically and continuously acquires Initialization, RTI data streaming and EOS information to allow the vehicle driver to view the fueling operations on a portable device's display via a computer software executable on a computer microprocessor.

### BRIEF DESCRIPTION OF THE DRAWINGS

The accompanying drawing figures incorporated in and forming a part of this specification illustrate several aspects of the invention, and together with the description serve to explain the principles of the invention.

FIG. 1 illustrates conventional fuel dispensing system.

FIG. 2 illustrates a top view of the conventional fuel dispensing system.

FIG. 3 illustrates the fuel dispensing system with a secondary display according to the embodiment of the present invention.

FIG. 4 illustrates the information suggested to be shown on the secondary display.

FIG. 5 illustrates the two possible parking orientations a vehicle according to the location of the fuel tank opening.

FIG. 6 illustrates the secondary displays being controlled directly by the pump computer.

FIG. 7 illustrates the secondary displays being controlled directly by a Dedicated Pump Controller.

FIG. 8 illustrates the secondary displays being controlled wirelessly by a Dedicated Pump Controller.

FIG. 9 illustrates a secondary display positioned on top and ahead of the vehicle supported by the roof structure.

FIG. 10 illustrates a secondary display positioned on the side of the dispenser in an angle to allow side and back view from the drivers position.

FIG. 11 illustrates is a top view of FIG. 10 with the vehicle parking the two possible parking orientations according to the location of the fuel tank opening.

### DETAILED DESCRIPTION OF THE DISCLOSURE

The embodiments set forth below represent the necessary information to enable those skilled in the art to practice the invention and illustrate the bet mode of practicing the invention. Upon reading the following description in light of the accompanying drawing figures, those skilled in the art will understand the concepts of the invention and will recognize applications of these concepts not particularly addressed herein. It should be understood that these concepts and applications fall within the scope of the disclosure and the accompanying claims.

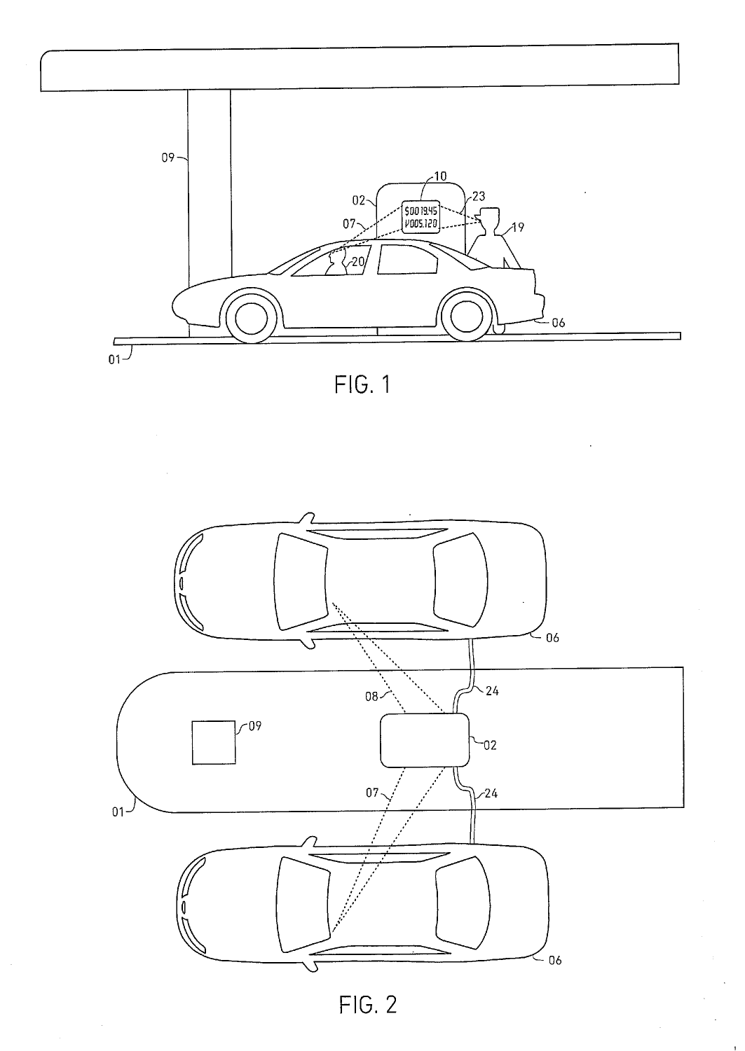

FIG. 1 is a conventional fuel dispensing system showing a gas station attendant 19 is fueling a vehicle 06 from a fuel dispenser 02. The fuel dispenser has a primary display 10 that is not in a field of view 23 of a vehicle driver 07.

FIG. 2 is a top view of the conventional fuel dispensing system showing a deficiency of the primary displays of the conventional fuel dispensers 02 not in the fields of view 07 and 08. The vehicle driver cannot see the displays of the fuel dispenser 02.

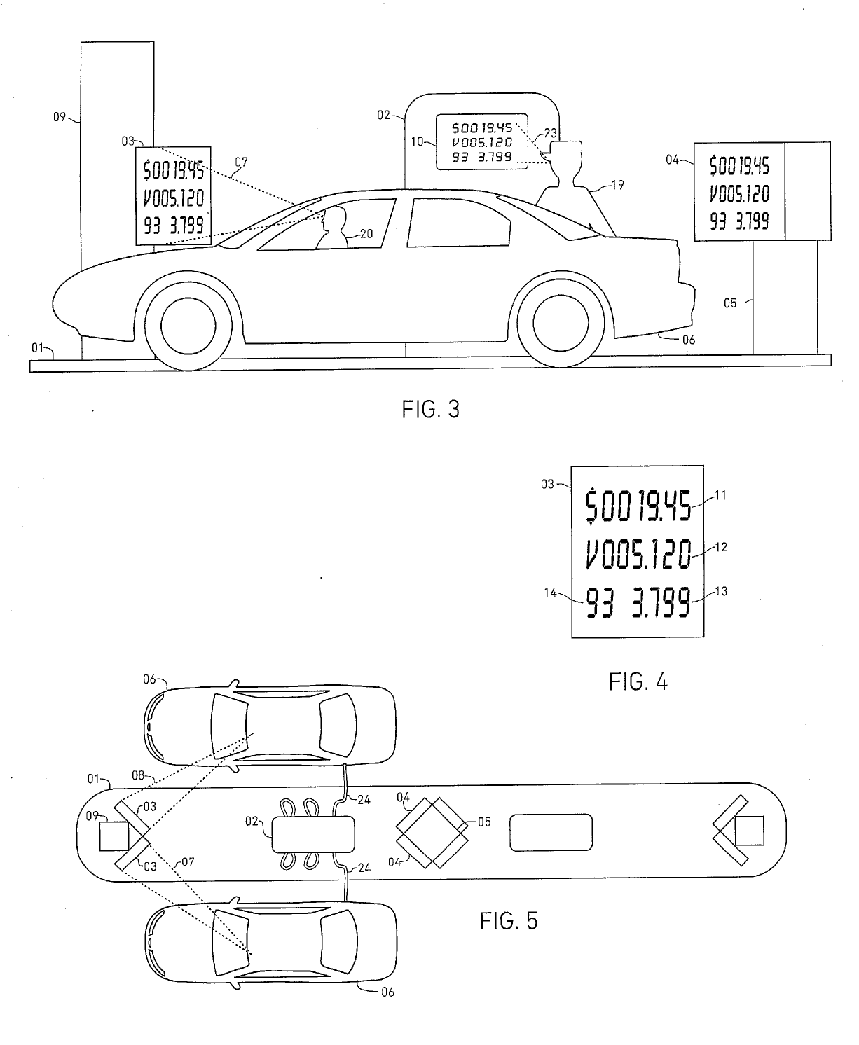

FIG. 3 shows the gas station attendant 19 fueling the vehicle 06 from the fuel dispenser 02 and monitoring the fueling operation from a secondary display screen 03. The secondary display screen 03 is within the field of view 07 of the vehicle driver 20 and within the field of view 23 of the attendant 19.

Still in FIG. 3, additional secondary display screen 04 in different location showing the same information with the secondary display screen 03 to the vehicle driver 20. The mechanical support structure of the secondary display can be a part of the island structure column 09 to support the roof or an independent structure like a pedestal 05.

FIG. 4 illustrates the information to be displayed on the secondary display 03, including current or final amount of money 11, current or final volume 12, PPU 13, and selected product of fuel 14 to be dispensed.

FIG. 5 shows the positions of the secondary displays 03 suitable within the fields of view 07 and 08 to the vehicle driver 06 in different sides of the fuel island. When the vehicle 06 has the fuel tank opening to connect the fuel nozzle 24 on its left side, the field of view 08 is visible to the vehicle driver. When the vehicle has the fuel tank opening to connect the fuel nozzle 24 on its right side, the field of view 07 is visible to the vehicle driver.

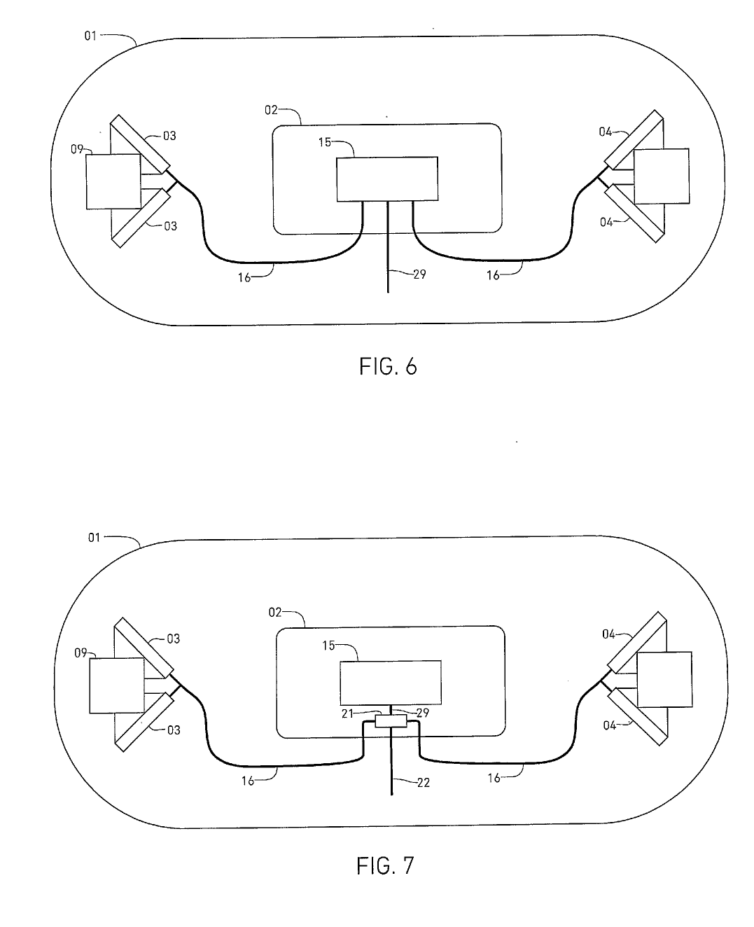

FIG. 6 shows the RTI and EOS information relating to a fueling operation being transmitted directly from the fuel dispenser's pump computer 15 located inside the dispenser 02 via cables 16 into one or more secondary displays 03. The secondary displays are mechanically supported by a structure 09 like a metal column in the fuel island 01. The pump computer's data line 29 is available for an external control system.

FIG. 7 shows the Initialization, RTI and EOS information pertaining fuel operation from the fuel dispenser's pump computer 15 having a Dedicated Pump Controller 21. The information collected by the Dedicated Pump Controller via the Pump Computer data line 22 and is transmitted to the secondary display 03 via cables 16. The communication with the pump computer's data line 29 for an external control system is available via the Dedicated Pump Controller's data line 22.

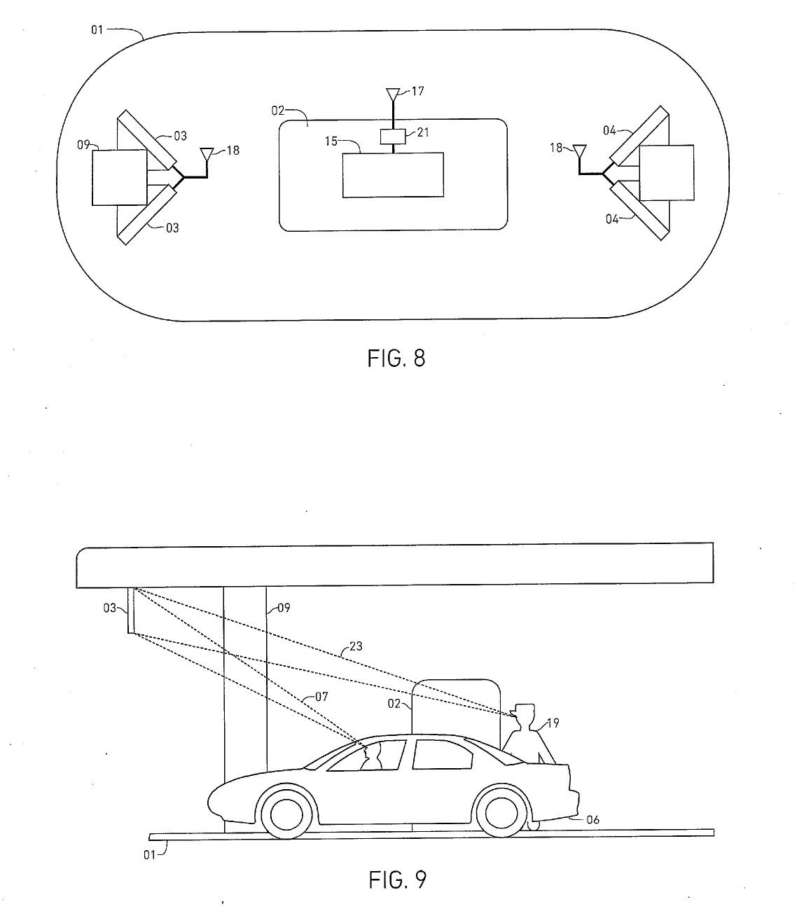

FIG. 8 shows the Initialization, RTI and EOS information pertaining fuel operation from the fuel dispenser's pump computer 15 having a Dedicated Pump Controller 21. The information is transmitted to the secondary display 03 via wireless transceivers and antenna 17 and 18.

FIG. 9 describes the secondary display 03 located in front of the vehicle 06 where the vehicle driver can see via the field of view 07 and the gas station attendant can see via the field of view 08.

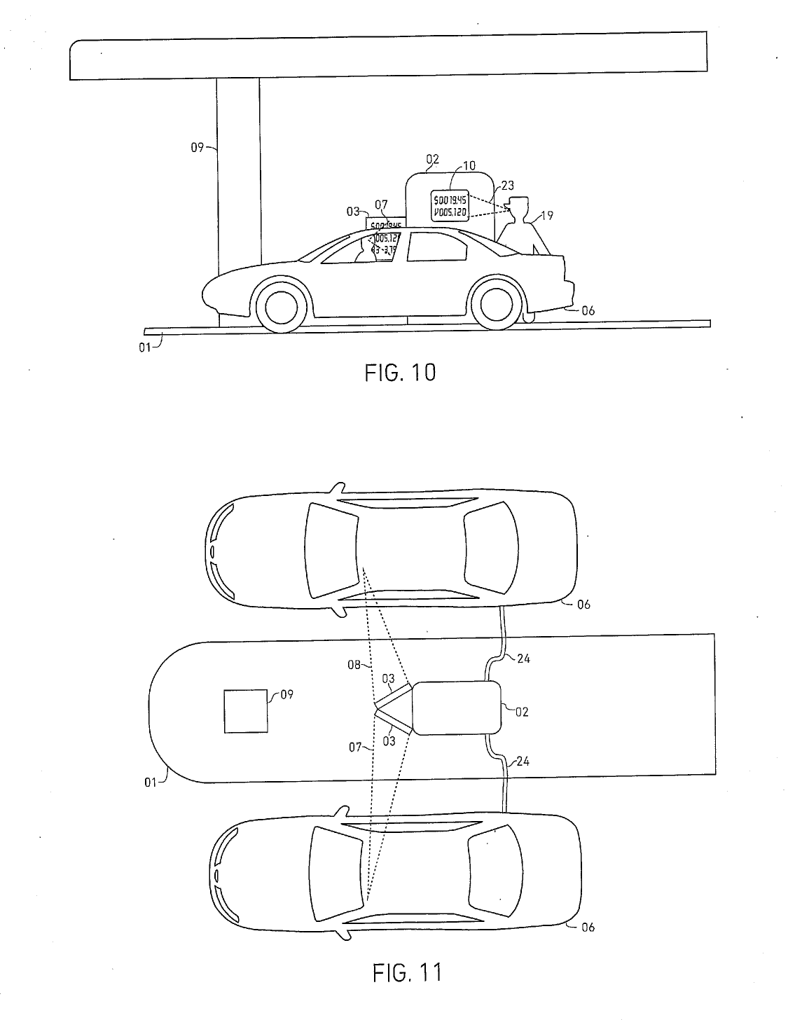

FIG. 10 shows the secondary display 03 attached on a side of the dispenser 02. The secondary display 03 is positioned lower than the primary display 10. Alternatively, the secondary display 03 is positioned at an angle to allow a convenient field of view 07 to be visible to the vehicle driver. A primary display 10 may create a field of view 10 to the gas station attendant 19.

FIG. 11 shows the field of view 07 when the vehicle has the tank opening on the opposite side of the driver's seat and a field of view 08 when a vehicle has the tank opening on the same side of the driver's seat.

As various modification could be made to the exemplary embodiments, as described above with reference to the corresponding illustrations, without departing from the scope of the invention, it is intended that all matter contained in the foregoing description and shown in the accompanying examples shall be interpreted as illustrative rather than limiting. Thus, the breadth and scope of the present invention should not be limited by any of the above described exemplary embodiments, but should be defined only in accordance with the following claims appended hereto and their equivalents.

Having illustrated and described the principles of the present invention in a preferred embodiment, it will be apparent to those skilled in the art that the embodiment can be modified in arrangement and detail without departing from such principles. Any and all such embodiments are intended to be included within the scope of the following claims.

What is claimed is:

1. A fuel dispensing system for displaying information concerning fuel dispensing, comprising:
(a) at least one fuel dispenser having a pump computer for dispensing fuel to customer's fuel container, wherein the fuel dispenser has one or more primary display;
(b) at least one secondary electronic display for displaying information data pertaining to fuel being dispensed, wherein the secondary electronic display screen having a field of view optimized to be seen by a driver seating in a vehicle; and
(c) at least one data communication channel that communicatively links the secondary electronic display to the fuel dispenser pump computer for synchronizing the information with the fuel dispenser metering system via the pump computer.

2. The fuel dispensing system of claim 1 wherein the fuel dispenser may include no primary display screen.

3. The fuel dispensing system of claim 1 wherein the pump computer is operatively connected to the secondary display screen via a wired connection.

4. The fuel dispensing system of claim 1 wherein the pump computer is operatively connected to the secondary display screen via a wireless connection.

5. The fuel dispensing system of claim 1 wherein the pump computer is operatively connected the secondary display screen via a dedicated pump controller.

6. The fuel dispensing system of claim 5 wherein the dedicated pump controller is operatively connected to the secondary display via a wired connection.

7. The fuel dispensing system of claim 5 wherein the dedicated pump controller is operatively connected to the secondary display via a wireless connection.
